(19) United States
(12) Patent Application Publication
(10) Pub. No.: US 2024/0377520 A1
(43) Pub. Date: Nov. 14, 2024

(54) SENSOR DEVICE AND OCCUPANT DETECTION DEVICE

(71) Applicant: Alps Alpine Co., Ltd., Tokyo (JP)

(72) Inventors: Hiroyuki TAKAOKA, Miyagi-ken (JP); Atsushi MURAI, Miyagi-ken (JP); Yukio OTAKI, Miyagi-ken (JP)

(21) Appl. No.: 18/778,154

(22) Filed: Jul. 19, 2024

Related U.S. Application Data
(63) Continuation of application No. PCT/JP2022/046267, filed on Dec. 15, 2022.

(30) Foreign Application Priority Data
Feb. 15, 2022 (JP) 2022-021547

(51) Int. Cl. G01S 13/04; G01S 13/88

(52) U.S. Cl. CPC G01S 13/04; G01S 13/88

(57) ABSTRACT

A sensor device includes an antenna and a reflector. The antenna transmits a radio wave as a transmission wave and receives a reflected wave. The reflector has a first reflecting portion that reflects a first transmission wave which is one of transmission waves, and a first reflected wave which is one of reflected waves. The sensor device has a first detection area and a second detection area. The first detection area receives a direct transmission wave, which is one of the transmission waves directly transmitted without being reflected by the reflector, while the second detection area receives the first transmission wave reflected by the first reflecting portion.

### CLAIM OF PRIORITY

This application is a Continuation of International Application No. PCT/JP2022/046267 filed on Dec. 15, 2022, which claims benefit of Japanese Patent Application No. 2022-021547 filed on Feb. 15, 2022. The entire contents of each application noted above are hereby incorporated by reference.

### BACKGROUND OF THE INVENTION

### 1. Field of the Invention

The present disclosure relates to a sensor device and an occupant detection device.

### 2. Description of the Related Art

A conventional occupant state detection system is attached in a vehicle having a plurality of seats including front seats and rear seats. The occupant state detection system has: a radio wave sensor that is attached above any of the plurality of seats and creates a sensor signal by transmitting a radio wave as a transmission wave and then receiving the radio wave reflected on an object as a reflected wave; a signal processing device that decides whether the object in a detection area is a person according to the sensor signal, and outputs a decision result; a seat-leaving detection unit that detects whether a seat-leaving state, in which a person has left from the front seat, has occurred; and a notification unit that outputs an alert if the signal processing device decides that the object in the detection area is a person when the seat-leaving detection unit detects the occurrence of the seat-leaving state (see Japanese Unexamined Patent Application Publication No. 2020-101415, for example).

With the conventional occupant state detection system, however, the detection area includes the whole of a plurality of rear seats, so the occupant state detection system does not detect the motion and state of a person in a particular area such as part of an individual seat.

### SUMMARY OF THE INVENTION

In view of this, the present disclosure provides a sensor device and an occupant detection device that can detect the motion and state of a person in a particular area.

A sensor device in an embodiment of the present disclosure includes: an antenna that transmits a radio wave as a transmission wave and receives a reflected wave; and a reflector having a first reflecting portion that reflects a first transmission wave, which is one of transmission waves, and a first reflected wave, which is one of reflected waves. The sensor device has: a first detection area in which a direct transmission wave, which is one of the transmission waves, arrives, the direct transmission wave being directly transmitted without being reflected by the reflector; and a second detection area in which the first transmission wave reflected by the first reflecting portion arrives.

It is possible to provide a sensor device and an occupant detection device that can detect the motion and state of a person in a particular area.

### BRIEF DESCRIPTION OF THE DRAWINGS

FIG. 1 illustrates a sensor device in an embodiment;

FIG. 2 is an exploded perspective view of the sensor device;

FIG. 3 is an enlarged view of the portion enclosed by the dashed lines in FIG. 1;

FIG. 4 illustrates an example of the structure of a radar;

FIG. 5 illustrates the interior of a vehicle;

FIG. 6 also illustrates the interior of the vehicle;

FIG. 7A illustrates detection areas during the parking of the vehicle;

FIG. 7B illustrates transmission waves that arrive in a CPD area, another CPD area, and an IMS area;

FIG. 8A illustrates a detection area and non-detection areas during the travel of the vehicle; and

FIG. 8B illustrates a transmission wave that arrives in an SBR area and transmission waves reflected to create two non-detection area.

### DESCRIPTION OF THE PREFERRED EMBODIMENTS

An embodiment to which a sensor device and occupant detection device of the present disclosure are applied will be described below.

### EMBODIMENT

### Structure of Sensor Device 100

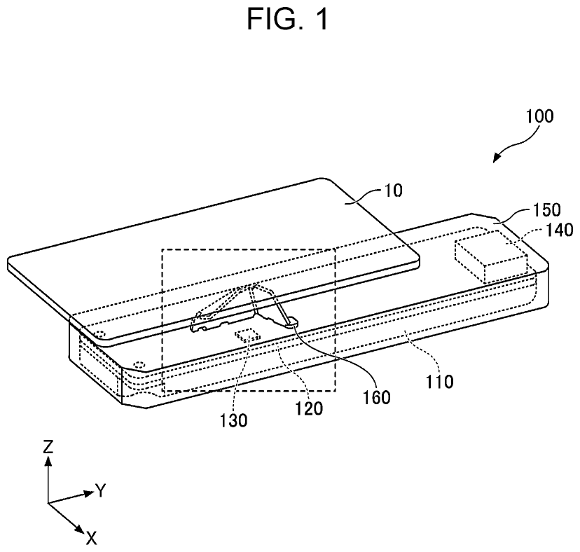

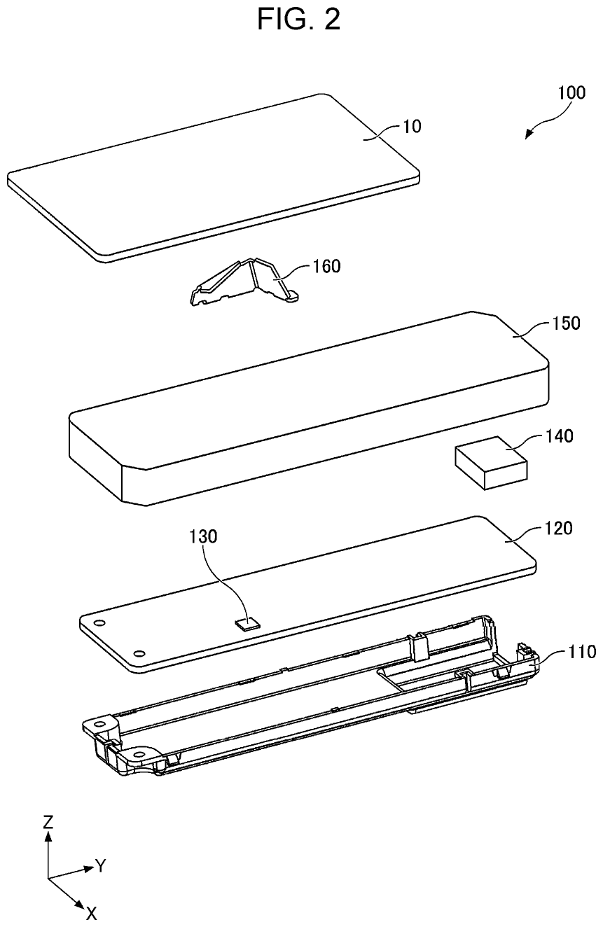

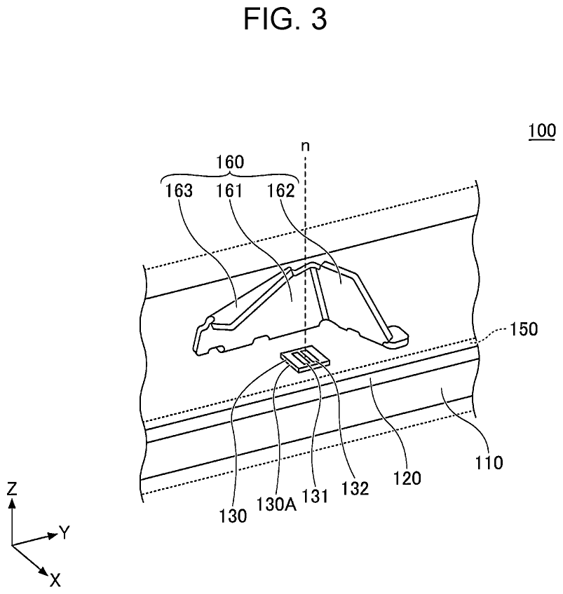

FIG. 1 illustrates a sensor device 100 in an embodiment. FIG. 2 is an exploded perspective view of the sensor device 100. FIG. 3 is an enlarged view of the portion enclosed by the dashed lines in FIG. 1.

The sensor device 100 is mounted in a vehicle as an example. The sensor device 100 receives a signal, as a reflected wave, that has been reflected on an occupant (person) or object in the vehicle, and detects a distance to the occupant or object according to a round-trip time from transmission to reception. The sensor device 100 has a plurality of detection areas and a plurality of non-detection areas to detect an occupant. The plurality of detection areas are eligible for detection of an occupant, and the plurality of non-detection areas are not eligible for detection of an occupant.

The description below is based on an XYZ coordinate system. For convenience of explanation, the −Z-direction side will refer to the lower side or bottom and the +Z-direction side will refer to the upper side or top. However, this does not represent a universal up-down relationship. Also, an XY-plane view will refer to a plan view. When the sensor device 100 is mounted in a vehicle, the Y direction is the travel direction (front-back direction) of the vehicle, as an example.

The sensor device 100 includes a bottom case 110, a circuit board 120, a radar 130, a connector 140, a case 150, and a reflector 160. The case 150 is an example of a cabinet. In FIGS. 1 and 2, a panel 10 provided on the upper side of the sensor device 100 is illustrated. The panel 10 is a resin cover that covers the sensor device 100 when the sensor device 100 is attached in the interior of the vehicle. In FIG. 3, the circuit board 120, radar 130, case 150, and reflector 160 are illustrated, and the case 150 is transparently illustrated.

The bottom case 110 is a resin case that covers the lower side of the sensor device 100. The sensor device 100 is attached to a vehicle body through a bracket or the like attached to the lower side of the bottom case 110.

The circuit board 120 is a wiring board on which the radar 130 is placed. The radar 130 and connector 140 are mounted on the upper surface of the circuit board 120. The radar 130 and connector 140 are connected together through wires on the circuit board 120.

The radar 130 has a substrate 130A, a transmission antenna 131, and a reception antenna 132 (see FIG. 3). The transmission antenna 131 and reception antenna 132 are an example of an antenna that transmits a radio wave as a transmission wave and receives a reflected wave. The transmission antenna 131 and reception antenna 132 are disposed at the center of the upper surface of the substrate 130A. The substrate 130A is square in plan view, as an example. The transmission antenna 131 transmits a radio wave as a transmission wave. The reception antenna 132 receives a reflected wave reflected on an object or the like. Although a transmission wave and reception wave of the radar 130 may be referred to below, this means that a transmission wave is transmitted by the transmission antenna 131 and a reflected wave is received by the reception antenna 132.

The transmission antenna 131 and reception antenna 132 are placed so as to be adjacent to each other in the Y direction. The Y direction is the travel direction (front-back direction) of the vehicle. In FIG. 3, the normal n of the radar 130 is indicated. The normal n passes through the center between the transmission antenna 131 and the reception antenna 132. The front direction of the transmission antenna 131 and reception antenna 132 is directed toward the +Z-direction side along the normal n.

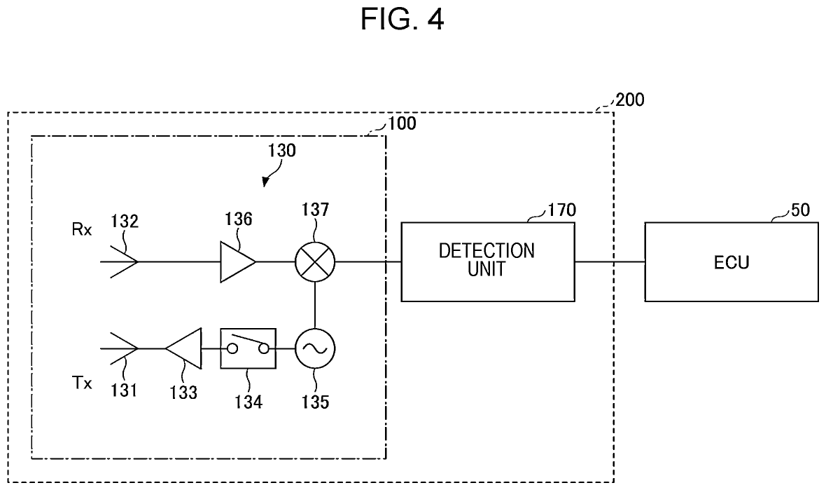

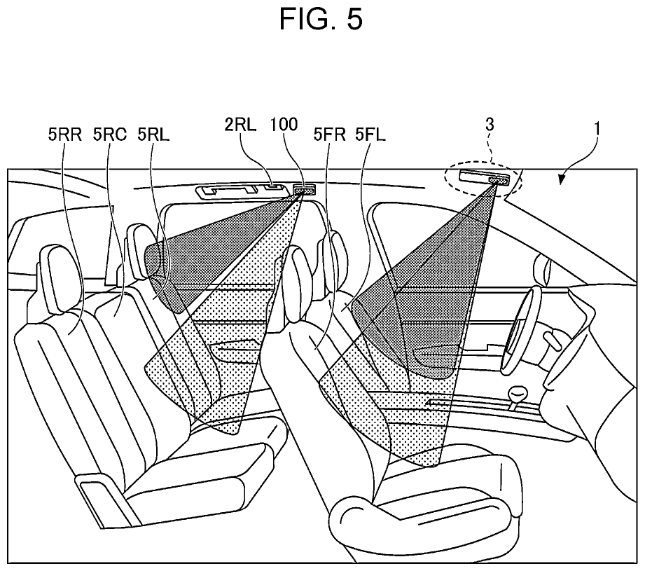

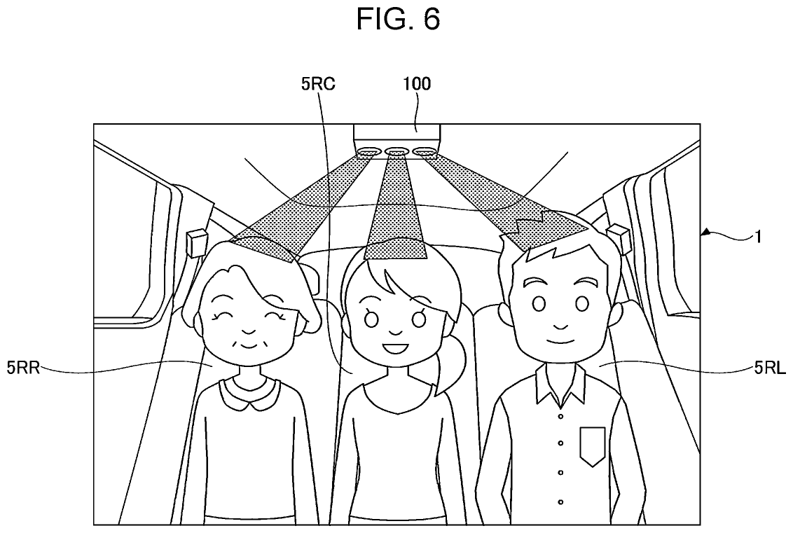

An occupant detection device 200, which is mounted in a vehicle as an example, detects a distance to an occupant or object according to a round-trip time from the transmission of a radio wave to the reception of it. As the radar 130, a pulse radar that can detect this type of round-trip time can be used as an example. The circuit structure of the radar 130 will be described later with reference to FIG. 4. The layout in the sensor device 100 including the radar 130 of this type will be described later by with reference to FIGS. 5 and 6.

The connector 140 connects the radar 130 to an ECU provided outside the sensor device 100.

The case 150 may be a resin cabinet that covers the upper surface side (first surface side) of the circuit board 120. The reflector 160 may be attached to the upper surface of the case 150.

The reflector 160, which is metallic, has a first reflecting plate 161, a second reflecting plate 162, and a third reflecting plate 163 as illustrated in FIG. 3. The first reflecting plate 161, second reflecting plate 162, and third reflecting plate 163 are respectively an example of a first reflecting portion, a second reflecting portion, and a third reflecting portion. The reflector 160 is attached to the upper surface of the case 150 so as to be positioned near the radar 130 in plan view. The first reflecting plate 161, second reflecting plate 162, and third reflecting plate 163 reflect a transmission wave of the radar 130, and reflect a reflected wave, which has been returned by being reflected on an object or the like, toward the radar 130.

The first reflecting plate 161 may be a plate-like member that is a metal plate substantially parallel to a YZ plane on the upper surface of the case 150, the upper end (an end in the +Z direction) of the metal plate being inclined so as to approach the transmission antenna 131 and reception antenna 132. The second reflecting plate 162 may be a plate-like member formed by inclining a metal plate substantially parallel to a ZX plane on the upper surface of the case 150 so as to approach the transmission antenna 131 and reception antenna 132. The first reflecting plate 161 and second reflecting plate 162 may be a plate-like member bent so as to be adjacent to each other. The third reflecting plate 163 may be part of the first reflecting plate 161 at its upper end on the −Y-direction side, the part being bent so as to approach the transmission antenna 131 and reception antenna 132. The reflector 160 of this type can be easily manufactured by cutting and bending a metal sheet or the like.

Part of the transmission waves of the radar 130 directly arrives at an object without being reflected on the reflector 160, after which the part is reflected on the object and returns to the radar 130 as a reflected wave. This type of radio wave is a direct wave. A direct wave included in the transmission waves transmitted by the radar 130 is a direct transmission wave. A direct wave included in the reflected waves received by the radar 130 is a direct reception wave. A detection area in which a direct transmission wave arrives and detection of an occupant is performed is an example of a first detection area.

The remaining part of the transmission waves of the radar 130 is reflected on the reflector 160 and arrives at the object as described above. The reflected wave reflected on the object is reflected again on the reflector 160 and returns to the radar 130. Of the transmission waves and reception waves reflected on the reflector 160, the transmission wave and reception wave reflected on the first reflecting plate 161 in this way are respectively examples of a first transmission wave and a first reception wave. Of the transmission waves and reception waves reflected on the reflector 160, the transmission wave and reception wave reflected on the second reflecting plate 162 are respectively examples of a second transmission wave and a second reception wave. Similarly, of the transmission waves and reception waves reflected on the reflector 160, the transmission wave and reception wave reflected on the third reflecting plate 163 are respectively examples of a third transmission wave and a third reception wave.

A detection area in which the first transmission wave arrives and detection of an occupant is performed is an example of a second detection area. Similarly, a detection in which the second transmission wave arrives and detection of an occupant is performed is an example of a third detection area. An area in which the third transmission wave arrives reflected on the third reflecting plate 163 and detection of an occupant is not performed is an example of a non-detection area. The non-detection area is part of an area other than the first detection area, second detection area, and third detection area.

Although an aspect will be described here in which the third reflecting plate 163 is a portion resulting from bending part of the upper end of the first reflecting plate 161, the third reflecting plate 163 may be a portion resulting from bending part of the upper end of the second reflecting plate 162. Alternatively, the third reflecting plate 163 may be a reflecting portion provided on the upper surface of the case 150 instead of a portion resulting from bending part of the upper end of the first reflecting plate 161 or second reflecting plate 162.

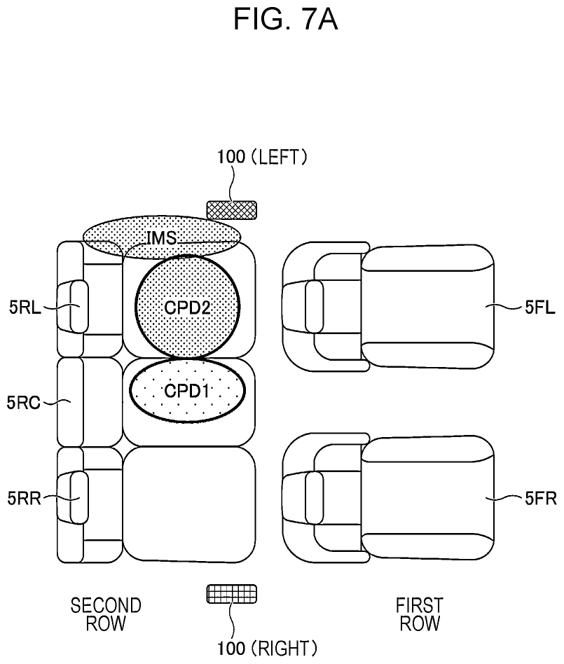

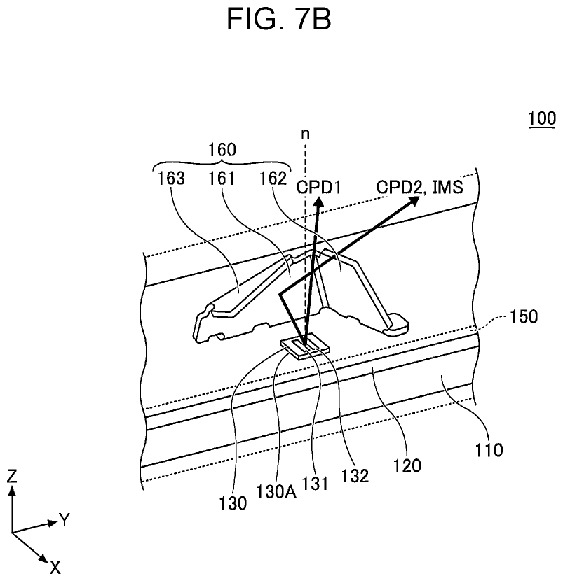

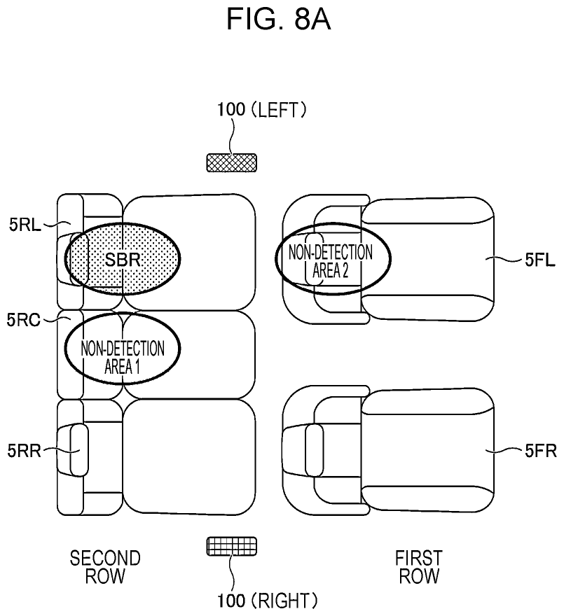

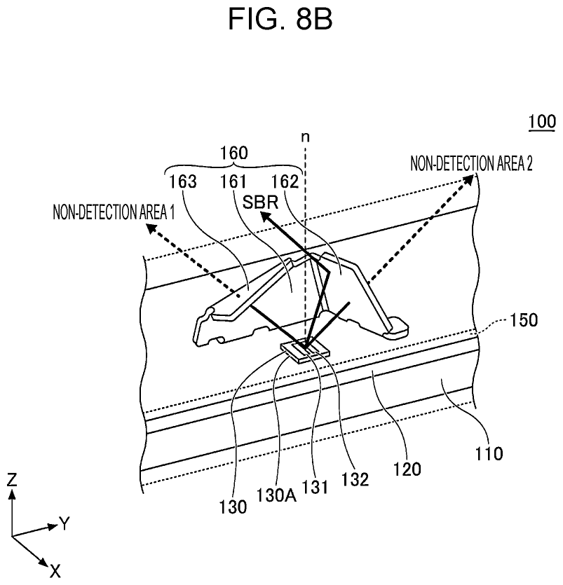

Wave reflection by the first reflecting plate 161, second reflecting plate 162, and third reflecting plate 163 as well as the first detection area, the second detection area, the third detection area, and the non-detection area will be described later with reference to FIGS. 7A to 8B.

### Structures of the Radar 130 and Occupant Detection Device 200

FIG. 4 illustrates an example of the structures of the radar 130 and occupant detection device 200. In FIG. 4, an electronic control unit (ECU) 50 is illustrated besides the occupant detection device 200. The occupant detection device 200 includes the sensor device 100 and a detection unit 170. In FIG. 4, only the radar 130 is illustrated as the constituent element of the sensor device 100; other constituent elements are omitted.

The radar 130 has the transmission antenna 131, the reception antenna 132, a power amplifier (PA) 133, a switch 134, a signal output unit 135, a low-noise amplifier (LNA) 136, and a mixer 137. The detection unit 170 is connected to the output side of the mixer 137.

The occupant detection device 200 is disposed in the interior of a vehicle. The occupant detection device 200 transmits a transmission wave (electromagnetic wave) of the radar 130 from the transmission antenna 131, receives, at the reception antenna 132, a signal, as a reflected wave, that has been reflected on an occupant or object in the interior of the vehicle, and detects whether an occupant is present in the interior of the vehicle according to the received signal. Specifically, the occupant detection device 200 detects the distance to an occupant or object according to the round-trip time from transmission from the transmission antenna 131 to the reception of a reflected wave. An occupant or object in the interior of the vehicle is an example of a detectable object. Since the signal intensity of the reflected wave changes depending on the material of the object, the shape (orientation) of the reflecting surface, and the like, when the object moves, the intensity of the reflected wave changes. Only the occupant moves in the interior of the vehicle, so the occupant can be detected.

The transmission antenna 131 is connected to the signal output unit 135 through the PA 133 and switch 134. The transmission antenna 131 transmits, to the interior of the vehicle, a transmission wave that has been output from the signal output unit 135, has passed through the switch 134, and has been amplified in the PA 133.

The reception antenna 132 is connected to the LNA 136. The reception antenna 132 receives a signal, as a reflected wave, that has been output from the transmission antenna 131 and has been reflected on an occupant or object in the interior of the vehicle, and outputs the signal to the LNA 136.

The PA 133 is disposed between the switch 134 and the transmission antenna 131. The PA 133 amplifies a transmission wave that has been output from the signal output unit 135 and has been entered through the switch 134, after which the PA 133 outputs the amplified transmission wave to the transmission antenna 131.

The LNA 136 is disposed between the reception antenna 132 and the mixer 137. The LNA 136 amplifies a signal received at the reception antenna 132 in a low-noise state and outputs the amplified signal to the mixer 137.

The switch 134 is disposed between the signal output unit 135 and the PA 133. The switch 134 is turned on at predetermined sampling intervals under control of the detection unit 170, and outputs a transmission wave to the PA 133. The predetermined sampling interval is 20 Hz as an example.

The signal output unit 135 outputs a transmission wave used to detect an occupant or object in the interior of the vehicle. The signal output unit 135 has two output terminals, one of which is connected to the switch 134 and the other of which is connected to the mixer 137.

The mixer 137 is connected to the output terminal of the LNA 136, to the output terminal of the signal output unit 135, and to the input terminal of the detection unit 170. The mixer 137 combines (down-converts) a signal entered from LNA 136 with a signal having the same frequency as a transmission wave entered from the signal output unit 135, and outputs the combined signal to the input terminal of the detection unit 170 as a reception signal representing the reflection level of a reflected wave. When there is no reflection, the reflection level is a noise floor.

Since detection is performed once when the switch 134 is turned on once, detection is performed at sampling intervals at which the switch 134 is turned on. As an example, to decide whether an occupant is present on a seat placed in the interior of the vehicle, a transmission wave is transmitted from the transmission antenna 131 toward the seat surface of the seat and a reflected wave is received at the reception antenna 132. In one detection, it is decided whether an occupant is present in space between the transmission antenna 131 and reception antenna 132 and the seat surface of a seat placed in the interior of the vehicle in directions between the transmission antenna 131 and reception antenna 132 and the seat surface of the seat.

The detection unit 170 is implemented by a computer including a central processing unit (CPU), a random-access memory (RAM), a read-only memory (ROM), an input/output interface, an internal bus, and the like.

The detection unit 170 compares the intensity of a reception signal with a threshold value, which is set to decide whether an occupant is present, and detects whether an occupant is present according to the comparison result. Since a round-trip time to an occupant or object varies, it is possible to decide whether an occupant is present.

The ECU 50, which is one of control devices for the vehicle, is connected to the detection unit 170. The detection unit 170 notifies the ECU 50 of a decision result.

### Placement of Radar 130

FIG. 5 illustrates the interior of the vehicle 1. In FIG. 5, a right front seat 5FR, a left front seat 5FL, a right rear seat 5RR, a center rear seat 5RC, and a left rear seat 5RL are illustrated.

The sensor device 100 can be placed near a room lamp 2RL on the ceiling above a rear side window on the left side of the interior of the vehicle 1, as an example. In this case, it suffices to attach another sensor device 100 to the ceiling above a rear side window on the right side as well. Then, it is possible to detect occupants or objects on the right rear seat 5RR, center rear seat 5RC, and left rear seat 5RL as well as around these seats. When the sensor device 100 is placed in an overhead console 3 on the ceiling above the center of the front seats in the interior or in the vicinity of the overhead console 3, it is also possible to detect occupants or objects on the right front seat 5FR and left front seat 5FL as well as around these seats.

FIG. 6 illustrates the interior of the vehicle 1. In FIG. 6, the right rear seat 5RR, center rear seat 5RC, and left rear seat 5RL are indicated. The sensor device 100 illustrated in FIG. 6 incorporates three radars 130. The sensor device 100 may be disposed at the center of the ceiling of the interior of the vehicle 1, as illustrated in FIG. 6. Then, it is possible to detect occupants or objects on the right rear seat 5RR, center rear seat 5RC, and left rear seat 5RL as well as around these seats. As described above, the sensor device 100 is disposed on the ceiling of the interior of the vehicle 1, as illustrated in FIGS. 5 and 6.

### Detection Areas during Parking of Vehicle 1

FIG. 7A illustrates detection areas during the parking of the vehicle 1. In FIG. 7A, a child presence detection (CPD) area 1, a CPD area 2, and an intruder monitoring system (IMS) area are illustrated as detection areas used by in the sensor device 100 on the left side, the sensor device 100 being placed near the room lamp 2RL on the ceiling above the rear side window on the left side of the interior of the vehicle 1. The CPD area 1 is an example of a first detection area. The CPD area 2 and IMS area are each an example of a second detection area.

The distances of the CPD area 1, CPD area 2, and IMS area from the sensor device 100 fall within a predetermined range. Since the sensor device 100 detects a distance to an occupant or object according to the round-trip time taken by a transmission wave and reception wave, the occupant detection device 200 detects whether an occupant or object is present in the CPD area 1, CPD area 2, and IMS area.

The CPD area 1 and CPD area 2 are used to detect an unattended child (CPD). During the parking of the vehicle 1, it is detected whether young children are left on the center rear seat 5RC and left rear seat 5RL or babies are left on car seats on these seats. The CPD area 1 and CPD area 2 are positioned in an area in which the seat surfaces of the center rear seat 5RC and left rear seat 5RL are present in plan view. In the height direction, these areas are positioned in a range within several tens of centimeters (about 20 cm to about 50 cm) from the seat surfaces of the center rear seat 5RC and left rear seat 5RL. To detect young children or babies on car seats, the range of the CPD area 1 and CPD area 2 in the height direction is set within several tens of centimeters from the seat surfaces of the center rear seat 5RC and left rear seat 5RL. For the right rear seat 5RR, it suffices to use the sensor device 100 on the right for detection purposes.

The IMS area is an area used for intruder detection for crime prevention (IMS). The IMS area is used to detect an intruder or the like who destroys the rear side window on the left side and extends his or her arm into the interior for a theft such as a car break-in during the parking of the vehicle 1. The IMS area is positioned inside the rear side window on the left side in plan view. In the height direction, the IMS area is positioned within the range from 10 cm to 50 cm from the ceiling, the range being equivalent to the height of the side window in the height direction. On the right side, it suffices to use the sensor device 100 on the right side for detection purposes. The sensor device 100 detects an intruder similarly as with an occupant.

FIG. 7B illustrates transmission waves that arrive in the CPD area 1, CPD area 2, and IMS area. Of the transmission waves, the direct wave propagates toward the CPD area 1. Also, of the transmission waves, a first reflected wave reflected on the first reflecting plate 161 propagates toward the CPD area 2 and IMS area. That is, in the CPD area 1, the direct wave arrives. In the CPD area 2 and IMS area, the first reflected wave arrives.

### Detection Area during Travel of Vehicle 1

FIG. 8A illustrates a detection area and non-detection areas during the travel of the vehicle 1. Specifically, FIG. 8A illustrates a seat belt reminder (SBR) area, in which the sensor device 100 placed near the room lamp 2RL on the upper side of the rear side window on the left side in the interior of the vehicle 1 make a detection, and also illustrates a non-detection area 1 and a non-detection area 2, in which the sensor device 100 does not make a detection. The SBR area is an example of the third detection area.

In the SBR area, a seat belt reminder is enabled for an occupant during the travel of the vehicle 1. The SBR area illustrated in FIG. 8A is an area for an occupant on the left rear seat 5RL. When a seat belt reminder is enabled for the left rear seat 5RL, the occupant on the left rear seat 5RL is detected during a travel and other occupants must not be detected. The SBR area at the left rear seat 5RL is set to a height at which whether the head of the occupant on the left rear seat 5RL is present is detected to detect whether the occupant is present. The SBR area is positioned in an area in which the back of the left rear seat 5RL is present in plan view. In the height direction, the SBR area is positioned within the range from 10 cm to 40 cm from the ceiling.

The distance of the SBR area from the sensor device 100 falls within a predetermined range. Since the sensor device 100 detects a distance to an occupant or object according to the round-trip time taken by a transmission wave and reception wave, the occupant detection device 200 detects whether an occupant or object is present in the SBR area.

The non-detection area 1 and non-detection area 2 are areas in which occupants that must not be detected are present when whether an occupant is present on the left rear seat 5RL is detected with the sensor device 100 on the left side during the travel of the vehicle 1. Occupants on the center rear seat 5RC and left front seat 5FL need to be distinguished from an occupant on the left rear seat 5RL. Therefore, the non-detection area 1 and non-detection area 2 are respectively positioned in areas in which the center rear seat 5RC and left front seat 5FL are present in plan view. In the height direction, the non-detection area 1 and non-detection area 2 are positioned within the range from 10 cm to 40 cm from the ceiling.

FIG. 8B illustrates a transmission wave that arrives in the SBR area and transmission waves reflected to create the non-detection area 1 and non-detection area 2. Of the transmission waves, a second reflected wave reflected on the second reflecting plate 162 propagates toward the SBR area. That is, in the SBR area, the second reflected wave arrives. Part of the second reflected wave, which is one of the transmission waves, the part being reflected on the second reflecting plate 162, arrives an area other than the SBR area, CPD area 1, CPD area 2, and IMS area.

The non-detection area 2 is positioned in an area enclosing the SBR area, and is included in an area other than the SBR area, CPD area 1, CPD area 2, and IMS area. The positioning of the non-detection area 2 in an area enclosing the SBR area refers to the non-detection area 2 being an area having the possibility that there is a person who will sit in the vicinity of the SBR area in the detection of an occupant or object in the interior of the vehicle 1. Here, the area enclosing the SBR area is an area positioned at the center rear seat 5RC adjacent and to the right of the SBR area and positioned at the left front seat 5FL in front of the SBR area. The non-detection area 2 is positioned at the left front seat 5FL in front of the SBR area. This is because if an area in front of the SBR area is included in the detection area, it is not known that which seat, left rear seat 5RL or left front seat 5FL, a person is present on.

The second reflecting plate 162 may be shaped so that the non-detection area 2 is formed at the back of the second reflecting plate 162 when viewed from the radar 130. The second reflecting plate 162 is placed so that the non-detection area 2 is formed.

Of the transmission waves, the third transmission wave reflected on the third reflecting plate 163 propagates toward an area other than the non-detection area 1 positioned at the center rear seat 5RC. The non-detection area 1 in which no transmission wave arrives is implemented in this way. The vehicle 1 is positioned in an area enclosing the SBR area, and is included in an area other than the SBR area, CPD area 1, CPD area 2, and IMS area. The positioning of the non-detection area 1 in an area enclosing the SBR area refers to the non-detection area 1 being an area having the possibility that there is a person who will sit in the vicinity of a person who is likely to be in the SBR area in detection of an occupant or object in the interior of the vehicle 1. Here, the area enclosing the SBR area is an area positioned at the center rear seat 5RC adjacent and to the right of the SBR area and positioned at the left front seat 5FL in front of the SBR area. The non-detection area 1 is positioned at the center rear seat 5RC adjacent and to the right of the SBR. This is because if an area adjacent and to the right of the SBR area is included in the detection area, it is not known that which seat, left rear seat 5RL or center rear seat 5RC, a person is present on.

The third reflecting plate 163 may be shaped so that the non-detection area 1 is formed at the back of the third reflecting plate 163 when viewed from the radar 130. The third reflecting plate 163 is placed so that the non-detection area 1 is formed. This is also true for the first reflecting plate 161; the first reflecting plate 161 is shaped so that a predetermined non-detection area is formed at the back of the first reflecting plate 161 when viewed from the radar 130. Here, the predetermined non-detection area formed at the back of the first reflecting plate 161 is not used.

When the sensor device 100 sends an output, there is no distinction among the CPD area 1, CPD area 2, and IMS area illustrated in FIG. 7A and the SBR area illustrated in FIG. 8A. Therefore, when an occupant or the like is detected in any of the CPD area 1, CPD area 2, IMS area, and SBR area, the output of the sensor device 100 becomes a signal representing that an occupant or the like has been detected. When an occupant or the like is not detected in any of the CPD area 1, CPD area 2, IMS area, and SBR area, the output of the sensor device 100 becomes a signal representing that an occupant or the like has not been detected.

Therefore, the non-detection area 1 and non-detection area 2 must not be included in four detection areas, CPD area 1, CPD area 2, IMS area and SBR area, and are included in an area other than the first detection area, second detection area, and third detection area.

As described above, the sensor device 100 has: the CPD area 1 in which the direct transmission wave, which is one of the transmission waves, arrives, the direct transmission wave being directly transmitted without being reflected by the reflector 160; and the CPD area 2 and IMS area in which the first transmission wave reflected by the first reflecting plate 161 arrives. Therefore, it is possible to detect the motion and state of an occupant (person) in a particular area such as the CPD area 1, CPD area 2, or IMS area.

Therefore, it possible to provide the sensor device 100 that can detect the motion and state of a person in a particular area.

The reflector 160 may have the second reflecting plate 162 that reflects the second transmission wave, which is one of the transmission waves, and the second reflected wave, which is one of the reflected waves. The sensor device 100 may further have the SBR area in which the second transmission wave reflected by the second reflecting plate 162 arrives. Therefore, it is possible to provide the sensor device 100 and occupant detection device 200 that can detect the motions and states of persons in more particular areas.

The reflector 160 may further have the third reflecting plate 163 that reflects the third transmission wave, which is one of the transmission waves, so that the third transmission wave propagates to an area other than the CPD area 1, CPD area 2, IMS area, and SBR area. When the third transmission wave is reflected to an area other than the CPD area 1, CPD area 2, IMS area, and SBR area, the reflected wave does not arrive in the CPD area 1, CPD area 2, IMS area, or SBR area, so detection in the CPD area 1, CPD area 2, IMS area, and SBR area can be reliably performed.

The first reflecting plate 161 and second reflecting plate 162 may be a single plate-like member bent so as to be adjacent to each other. They may be inclined with respect to the front direction of the radar 130 so as to approach the radar 130. The third reflecting plate 163 may be a bent portion resulting from bending the tip of the first reflecting plate 161 or second reflecting plate 162 in a direction in which the tip approaches the radar 130. Therefore, the reflector 160 can be easily manufactured from a single metal plate or the like. Alternatively, the first reflecting plate 161 and second reflecting plate 162 may be manufactured from separate metal plates or the like. The third reflecting plate 163 may also be manufactured from a separate metal plate or the like. That is, the first reflecting plate 161, second reflecting plate 162, and third reflecting plate 163 may be formed separately, and the third reflecting plate 163 may be a portion attached to the tip of the first reflecting plate 161 or second reflecting plate 162 in a direction in which the third reflecting plate 163 approaches the radar 130.

The third reflecting plate 163 may be shaped so that a predetermined non-detection area is formed at the back of the third reflecting plate 163 when viewed from the radar 130. Therefore, a predetermined non-detection area can be reliably formed at the back of the third reflecting plate 163.

The third reflecting plate 163 may form a non-detection area in an area enclosing at least any one of the CPD area 1, CPD area 2, IMS area, and SBR area. Therefore, an occupant or object can be reliably detected in the CPD area 1, CPD area 2, IMS area, and SBR area.

The second reflecting plate 162 may be shaped so that the SBR area is formed and a predetermined non-detection area is formed at the back of the second reflecting plate 162 when viewed from the radar 130. Therefore, a non-detection area can be reliably formed at the back of the second reflecting plate 162.

The second reflecting plate 162 may form a non-detection area in an area enclosing at least any one of the CPD area 1, CPD area 2, IMS area, and SBR area. Therefore, an occupant or object can be reliably detected in the CPD area 1, CPD area 2, IMS area, and SBR.

The sensor device 100 may further include the circuit board 120 having a first surface, on which the radar 130 is placed, and the case 150, which covers the same side as the first surface of the circuit board 120. The reflector 160 may be disposed on the case 150. Therefore, the reflector 160 can be reliably positioned with respect to the radar 130, so the direct wave and reflected wave can be formed as designed.

The radar 130 may be attached to the ceiling of the interior of the vehicle 1. Therefore, a structure can be implemented in which an occupant or object can be easily detected in the detection area from above.

The occupant detection device 200 includes the detection unit 170 that detects a person (occupant) or object in the interior of the vehicle 1 according to the result of detection by the sensor device 100 mounted in the vehicle 1, so it is possible to provide the occupant detection device 200 that can detect the motion and state of a person in a particular area.

This completes the description of the sensor device and occupant detection device in an exemplary embodiment of the present disclosure. However, the present disclosure is not limited to specifically disclosed embodiments, but can be varied and modified in various other ways without departing from the scope of the claims.

What is claimed is:

1. A sensor device comprising:
an antenna that transmits a radio wave as a transmission wave and receives a reflected wave; and
a reflector having a first reflecting portion that reflects a first transmission wave, which is one of transmission waves, and a first reflected wave, which is one of reflected waves; wherein the sensor device has
a first detection area in which a direct transmission wave, which is one of the transmission waves, arrives, the direct transmission wave being directly transmitted without being reflected by the reflector, and
a second detection area in which the first transmission wave reflected by the first reflecting portion arrives.

2. The sensor device according to claim 1, wherein:
the reflector has a second reflecting portion that reflects a second transmission wave, which is one of the transmission waves, and a second reflected wave, which is one of the reflected waves, and
the sensor device further has a third detection area in which the second transmission wave reflected by the second reflecting portion arrives.

3. The sensor device according to claim 2, wherein the reflector further has a third reflecting portion that reflects a third transmission wave, which is one of the transmission waves, so that the third transmission wave propagates to an area other than the first detection area, the second detection area, and the third detection area.

4. The sensor device according to claim 3, wherein:
the first reflecting portion and the second reflecting portion are a single plate-like member bent so as to be adjacent to each other, the first reflecting portion and the second reflecting portion being inclined with respect to a front direction of the antenna so as to approach the antenna; and
the third reflecting portion is a bent portion resulting from bending a tip of the first reflecting portion or the second reflecting portion in a direction in which the tip approaches the antenna, or the first reflecting portion, the second reflecting portion, and the third reflecting portion are formed separately, the third reflecting portion being a portion attached to the tip of the first reflecting portion or to the tip of the second reflecting portion in a direction in which the third reflecting portion approaches the antenna.

5. The sensor device according to claim 3, wherein the third reflecting portion is shaped so that a predetermined non-detection area is formed at a back of the third reflecting portion when viewed from the antenna.

6. The sensor device according to claim 5, wherein the third reflecting portion forms the predetermined non-detection area in an area enclosing at least any one of the first detection area, the second detection area, and the third detection area.

7. The sensor device according to claim 2, wherein the second reflecting portion is shaped so that the third detection area is formed and a predetermined non-detection area is formed at a back of the second reflecting portion when viewed from the antenna.

8. The sensor device according to claim 7, wherein the second reflecting portion forms the predetermined non-detection area in an area enclosing at least any one of the first detection area, the second detection area, and the third detection area.

9. The sensor device according to claim 1, further comprising:
a circuit board having a first surface, on which the antenna is placed; and
a cabinet, which covers a first surface side of the circuit board; wherein
the reflector is disposed on the cabinet.

10. The sensor device according to claim 1, wherein the antenna is attached to a ceiling of the interior of the vehicle.

11. An occupant detection device, comprising:
the sensor device according to claim 1, the sensor device being mounted in a vehicle; and
a detection unit that detects an occupant in the vehicle according to a result of detection by the sensor device mounted in the vehicle.
